(19) United States
(12) Patent Application Publication
(10) Pub. No.: US 2017/0144002 A1
(43) Pub. Date: May 25, 2017

(54) FIRE SUPPRESSION DEVICE

(71) Applicant: Shaviv BEN NERIA, Mevaseret (IL)

(72) Inventor: Shaviv BEN NERIA, Mevaseret (IL)

(21) Appl. No.: 15/021,942

(22) PCT Filed: Aug. 3, 2015
(86) PCT No.: PCT/IL2015/050800

§ 371 Date: Mar. 15, 2016

(30) Foreign Application Priority Data
Aug. 11, 2014 (IL) 234059

(51) Int. Cl. A62C 3/00; G08B 17/06; A62C 37/44; A62C 2/04; A62C 35/13

(52) U.S. Cl. CPC A62C 3/006; A62C 2/04; A62C 35/13; A62C 37/44; G08B 17/06; A62C 99/0027

(57) ABSTRACT

The system of the present invention is comprised of the following: a fire extinguisher; solenoid adapted to release said extinguisher; a flexible conduit adapted to direct the contents of the extinguisher to the stove; a linear heat detector for sensing fire; a disconnecting box adapted to disconnect the cooking gas or electricity from stove at the event of fire; a second CO2 gas or equivalent gas container that is connected to the disconnecting box; another solenoid adapted to release said gas container; more conduits connected to each of the burners in the stove. In this configuration, fire suppression, and gas cutoff are effected simultaneously. Additionally to the above mentioned effects, the system further simultaneously injects CO2 or similar extinguishing gas instead of natural gas straight to the burner itself suffocating the fire at the source.

### FIELD OF THE INVENTION

The present invention relates to the field of fire suppression devices, more particularly, to an affordable fire suppression device for home use.

### BACKGROUND OF THE INVENTION

Household cooking equipment (stoves, ranges, grills, etc) are a leading cause of domestic fires and related injuries. After heating equipment, stoves are the second most common cause of home fires and consequent injuries and death, according to the National Fire Protection Association (NFPA).

The most highly-recommended and commonly-used solution for residential use is the smoke alarm, which as will be appreciated, does not suppress the fire but only indicates smoke or outbreak of fire by audible means. This brings notice to but does not solve the problem, especially when the house owner is not present or if the alarm is tripped only when the fire has already spread and cannot be contained. These are just several reasons why the fire alarm is an insufficient and partial solution at best. Sprinkler system, if installed, will suppress a fire but will not shut off the source, which may be a gas line, electric line, or the like.

Existing fire suppression systems have a wide range of implementations, which in many cases do not eliminate the origin of the fire. If the suppression system is not of sufficient power, or is limited in time (e.g. a fire extinguisher with limited volume) the fire will often rapidly grow out of control. For example, fires fed by uninterrupted gas or electric supplies may continue even after activation of a suppression system.

Some small and medium size businesses can afford a “smart” industrial kitchen suppression fire system, which nowadays are very costly. In any case businesses are forced by law to implement such systems to prevent fatalities where large gathering of people generally occurs.

Current systems require inhabitants to play an active role in fighting a fire. In the case of stove fires fed by electric or gas sources, the inhabitants must risk their own lives, trying manually to shut off gas supplies or electricity switches in cases of fire. Professional guidance suggests leaving the house, letting the fire burn and not risking lives. Both routes are problematic, the first risking injury and the second property damage.

There thus remains a long-felt need for means to suppress kitchen/oven fires, requiring neither personal risk nor property damage.

The prior art below are components of costly industrial and commercial fire extinguishing systems. The components alone do not effectively handle residential fires.

U.S. Pat. No. 6,527,058 describes a pressurized container as a housing of the fire suppressing wet chemical for kitchen applications. Commonly referred as a “Fire Extinguisher”, this device aids in small fires and is not intended for use on larger fires, such as one which has reached the ceiling or that has spread through the interior. Further, the device is hand held which puts the user at direct risk of injury. It also requires a degree of skill and familiarity with the procedure of operating this hand held device. Kitchen fires can become out-of-control in seconds. In many cases the fire extinguisher is ineffective, as gas or electricity power keep adding fuel or electrical energy to the fire, feeding it despite suppression efforts downstream. The extinguisher has no detection system what so ever and requires external activation. Finally if the extinguisher is not directed to the source of the flame it will be entirely ineffective.

The following three patents all have specific elements which solve very specific problems but do not offer a unified solution for detection, alerting, disconnection of fuel source, nor suppression of the fire.

U.S. Pat. No. 5,297,636 describes a flexible hose connected to a nozzle for transferring contents of a fire extinguisher for residential cook stoves and ranges. A tube specially tailored for the carrying anti-fire materials is used, but does not inform of a fire eruption. By itself it also cannot stop the gas flow.

U.S. Pat. No. 3,713,493 describes a safety valve for discharging a fluid medium from a fire extinguisher. Malfunction of the valve is a common occurrence and can cause high probability of fatalities.

Both of the last patents are devices handling pressure levels in an anti-fire material tank and not a comprehensive solution for kitchen fires. The systems do not alert occupants of a fire. The devices do not make sounds or give any active indication that a fire occurred.

U.S. Pat. No. 4,175,677 describes a tubing detector positioned in the fire hazard area. This is a heat affected area, while the device is not heat proof. Further, U.S. Pat. No. 5,186,260 describes a sensor wire covered with a plastic insulation employed inside of a range hood, especially wires manufactured by “Protectowire”, Inc. This solution is a heavy duty wire which can be installed in sophisticated fire extinguishing systems. It is one element of a whole system that currently is not offered for common households. Such systems are only built for high risk commercial and industrial hazards and therefore do not aid common households. Further, it is not aesthetic nor convenient to have multiple wires routed through every corner of the house for purposes of fire detection; a more pinpoint solution is required.

The following patents are particular devices as part of full composed systems built in industrial or commercial usage; none are currently fit for homes.

U.S. Pat. No. 5,127,479 describes a micro switch operating either a gas valve or electrical switch via a 12-volt solenoid to shut off the supply of electricity or gas when the micro switch detects a discharge by the fire extinguisher.

U.S. Pat. No. 5,127,479 describes a horn activated upon operation of a micro switch by closing the normally open contact in 12-volt relay.

U.S. Pat. No. 5,127,479 describes a shut-off mechanism which shuts off electrical power or gas to the stove, Further U.S. Pat. No. 4,834,188 describes a micro switch closing normally open contact which interrupts gas or electricity.

There remains a long-felt need for an affordable residential range/stove fire extinguishing system.

### SUMMARY OF THE INVENTION

### Main Configurations

The present invention presents an independent fire suppression system for household stoves and ranges.

The system is comprised of the following: a fire extinguisher; solenoid adapted to release said extinguisher; a flexible conduit adapted to direct the contents of the extinguisher to the stove; a linear heat detector for sensing fire; a disconnecting box adapted to disconnect the cooking gas or electricity from stove at the event of fire.

The system is intended for gas stoves and is further comprised of a second CO2 gas or equivalent gas container that is connected to the disconnecting box; another solenoid adapted to release said gas container; more conduits connected to each of the burners in the stove.

In this configuration, fire suppression, and gas cutoff are effected simultaneously. Additionally to the above mentioned effects, the system further simultaneously injects CO2 or similar extinguishing gas instead of natural gas straight to the burner itself suffocating the fire at the source.

In another configuration at least one additional conduit is leading to at least 1 nozzle adjacent to the heat source of the stove.

In this second configuration, additionally to the above mentioned effects of the invention, the system further simultaneously injects CO2 or similar extinguishing gas instead of natural gas near the burner or electric heat source itself suffocating the fire at the source.

It is to be mentioned, that the CO2 container is also characterized at storing highly compressed CO2 or similar gas, which has inherently low temperature close to 0 degrees Celsius, which in an event of a fire, brings the environment temperature down close to zero in addition to the above mentioned effects.

The device has the potential to save life, and is more effective than any other existing product in the market for the specific target audience, such as household/apartment/condo residents. The system may be built with approved and rated components, which are not inordinately expensive and are intelligently engineered.

### Linear Heat Detector

The system detects fire by means of a linear heat detector. On sensing a fire, the fuel (or electrical supply) is shut off, a warning siren is activated, and simultaneously a suppression system is activated, these operations being entirely automatic and not requiring action on the part of the occupant (if indeed there are any).

### System Operation

Fire is sensed by the linear heat detector, and this signal is used to trigger the solenoid to activate the suppression system (which comprises an extinguisher). Simultaneously the device cuts off the electricity/gas to the range. A sounder alerts the residents and nearby neighbors. The sum of the components, composed in the specific manner of the invention creates a new function for an entire population in need.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 presents a system diagram consistent with certain embodiments of the invention;

FIG. 2 presents a system diagram consistent with certain embodiments of the invention;

FIG. 3 presents a circuit diagram consistent with certain embodiments of the invention; and,

FIG. 4 presents a circuit diagram consistent with certain embodiments of the invention; and,

### DETAILED DESCRIPTION OF THE PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

Nearly half all of U.S. home fires originate in the kitchen and involve cooking equipment. 38% of home fire injuries and 15% of home fire deaths result from such fires. [NFPA 2006-2010 “Home Fires involving Cooking Equipment”, November 2012].

Amongst such kitchen fires, 58% start on a range or cook top. Given the total number of reported fires in the U.S. involving cooking equipment in the 5 year period 2006-2010 of 157,300, and the average cost to repair/restore a house fire of $49,000, one arrives at over $1B USD lost to range fires every year in the U.S. alone.

The present invention provides a method for sensing and suppressing such fires.

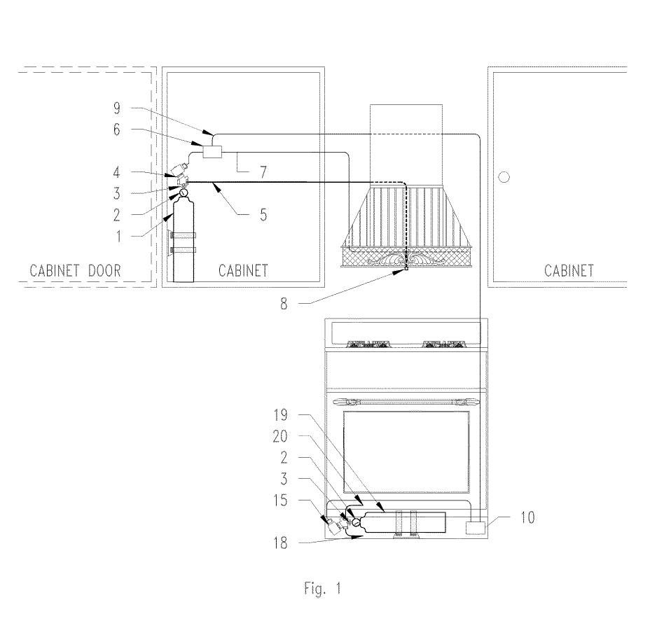

With reference to FIG. 1, fire is sensed by a linear heat detector 7. This signal is used to activate a relay 17 housed in the disconnecting box 10. This relay 17 cuts off the electricity (or flow of gas) to the range and makes the sounder 11 go off. In parallel, this signal turns on the solenoid 4 thus activating the suppression.

All components of the system are already or are in the process of approving by UL, including the Wet Chemical Agent Compressed Cylinder 1, gauge 2, safety valve 3, solenoid valve 4 with flexible conduit 5 connected to a nozzle 8, a linear heat detector 7, wiring 9, a junction box 6, disconnecting box 10 with a sounder 11 and low voltage supply unit 12, equipped with a range receptacle 13 and wired range plug 14.

The invention further comprise a compressed carbon dioxide or similar gas container 19 connected to said disconnecting box, and further connected to a multi-way solenoid valve 15 adapted to inject carbon dioxide through a plurality of conduits 18, 20. Wherein said conduits 18, 20 are each conveying said gas through a burner of the stove when a fire is detected. This allows for diluting oxygen in the vicinity of the fire source and inside the burner/coil units and thereby extinguishing it.

The multi-way solenoid valve 15 is adapted to allow the flow of said gas into a plurality of conduits 18, 20 as required by the quantity of burners in the stove. This property is in contrast to the regular solenoid 4, which is adapted to allow the discharge of extinguisher 1 only through one conduit 5.

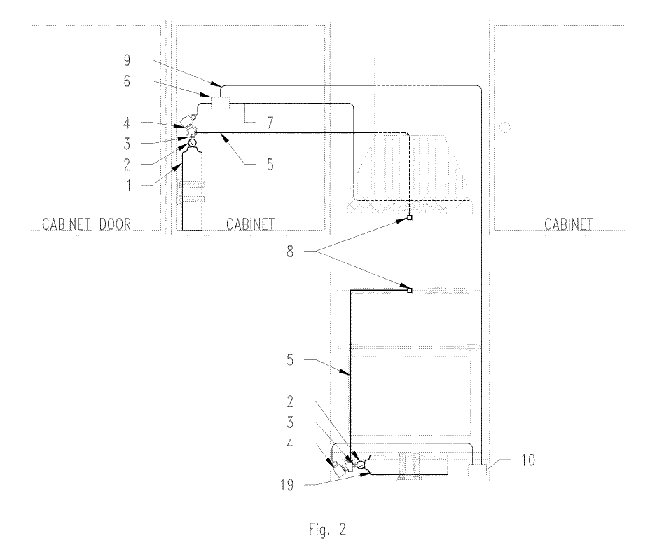

Referring now to FIG. 2, the invention may further comprise a compressed carbon dioxide or an equivalent gas container 19 connected to the disconnecting box 10 and adapted to inject said gas through a nozzle 8 adjacent to the heat source for the purposes of diluting oxygen at the fire source and thereby extinguishing it.

### The Disconnecting Box

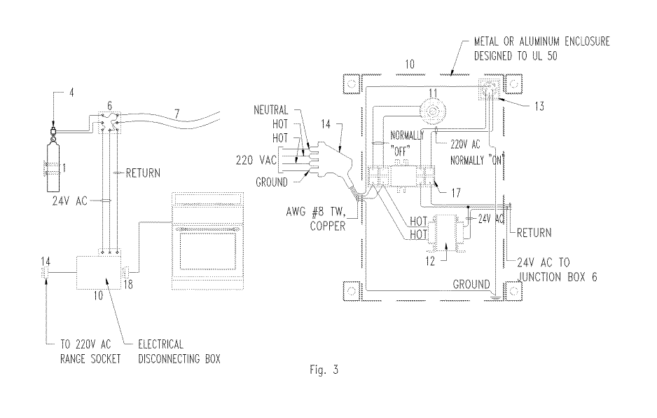

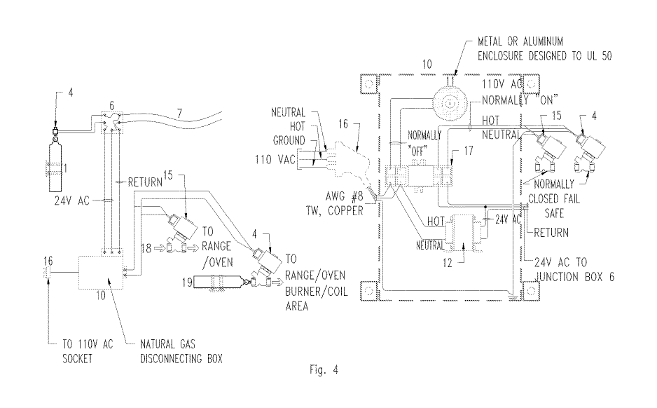

With reference to FIGS. 3-4. For LNG oven/ranges the range disconnection box 10 controls the gas supply 18 via a Residential Gas Control Valve (UL approved) 15 and is equipped with a standard power plug 16. For the case of electric ranges, the range disconnection box simply comprises an outlet 13 of which the range must be connected to 18 The components of the disconnecting box 10 of FIG. 1 are depicted in FIG. 4 and FIG. 5. Here one sees the plug 14/16 (and outlet 13 in the electrical box), as well as transformer 12 and relay 17. The device is plugged in using the standard/range wall plug 14/16. This powers the 110VAC/220VAC to 24VAC transformer 12, and this signal is run along the linear heat detector 7. When a fire event is detected, the heat detector 7 activates the fire extinguisher 1 (via its solenoid 4), shutting off the gas or electric supply to the range via the relay 17, and activates the alarm sounder 11.

This system is subject to approval by the UL in accordance to UL Subject 300A which comprises requirements of fire suppression (a given amount of oil in a given amount of time, at a defined distance and over a defined area). A further alarm and panel notification (not shown) are not mandatory but may also be included in the system for purposes of notifying users of status (e.g. ‘normal’ vs. ‘fire’).

It is within provision of the invention to disconnect range electrical power (or gas supply in the case of a gas range) in the event of fire detection. In this way, an energy source that would otherwise feed the fire, is eliminated.

### Restoring Operation After Fire

To restore power to the oven, the linear heat detector must be replaced, and the cylinder is refilled and compressed by a licensed service. The linear heat detector must be replaced since after a fire it has shorted closed and will thereby signal a fire forever after; pulling apart the linear detector will generally be impossible since the conductive elements will have fused together, and even if this has not occurred, an element that has already shorted closed cannot be used again according to fire code restrictions; it must be replaced with a new, unshorted element.

Meanwhile, the customer may bypass the system and connect the power plug directly to the wall receptacle.

### Further Embodiments

It is known in the art to use compressed wet chemical agent cylinders, and to employ a nozzle and flex conduit connected thereto. The use of sounders are found in existing patents, as well as the use of a range disconnection box.

However the use of gauge and safety valve (which secures discharge of agent before the system is installed and inspected) is novel, as is the use of a linear heat detector or cable type flame detector. Furthermore the use of a solenoid valve actuating unit is novel.

It is within provision of the invention that no manual operation is required in the case of fire; the fire is extinguished and range disconnected automatically, reducing the risk of injury entailed when trying to manually shut off gas or electric supply to a range engulfed in a fiery inferno.

It is within provision of the invention to further utilize a control unit such as a microprocessor-based control unit adapted to immediately notify remote entities of the fire event. This may be accomplished by means of an audible alarm, visible indicator, cellular and/or land line communications (for instance playing a recorded announcement or sending an SMS), and internet connection (for instance sending an email notification). The control unit may be connected electrically to the fire detection means as will be clear to one skilled in the art. These notifications may be sent for instance to the house or apartment owner and/or resident, as well as relevant authorities such as the fire department.

The internet or cellular connection referred to above may be used to transmit information concerning a fire to the cloud (e.g. a local or remote net-connected server) thereby allowing devices including smart phones, tablets, and other network connected devices to observe said information, either actively or passively. Furthermore this server may be in electronic communication with additional system elements such as breakers for the household mains electricity, comprehensive detection system which serves the entire building/complex, a deluge sprinkler systems, specific electrical switches of the household, flow controllers for gas supply, and the like.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

1. An independent fire suppression system for household gas stoves and ranges comprising:
a. a compressed wet chemical extinguisher and gauge in fluid communication therewith;
b. a solenoid adapted to allow the release of contents of said extinguisher;
c. a flexible, heat proof conduit adapted to direct the contents of said extinguisher to said stove;
d. a supply line adapted to provide electrical power or fuel to said range;
e. a linear heat detector adapted to sense fire from said range;
f. a disconnecting box adapted to disconnect said supply line when said linear heat detector detects extreme heat;
g. a compressed carbon dioxide or equivalent gas container connected to said disconnecting box adapted to inject said gas- through a burner of said stove for the purposes of diluting oxygen in the vicinity of fire source and thereby extinguishing it.
wherein fire suppression, and gas cutoff, are all effected simultaneously by use of a linear heat sensor.

2. The system as described in claim 1, wherein said compressed carbon dioxide or equivalent gas container connected to said disconnecting box adapted to inject said gas through a nozzle adjacent to the heat source for the purposes of diluting oxygen in the vicinity of the fire source and thereby extinguishing it.

3. The system as described in claim 1, further comprising a control unit enabling immediate notification of remote entities by means selected from: land line, cellular connection, internet connection.

4. The device of claim 3 wherein said internet connection is used to transmit information concerning a fire to the cloud thereby allowing devices including smart phones, tablets, and other network connected devices to observe said information and control actuators selected from the group consisting of: household main electricity switch, sprinkler systems, specific electrical switches of the household, flow controllers for gas supply.

5. The system as described in claim 1, further comprising an alarm in connection to said disconnecting box, wherein, upon a fire said disconnecting box activates said alarm.
